(19) United States
(12) Patent Application Publication
(10) Pub. No.: US 2013/0202804 A1
(43) Pub. Date: Aug. 8, 2013

(54) DISPERSIONS OF HIGH STRENGTH POLYMERS AND METHODS OF PREPARING SAME

(71) Applicants: Mark S. Bailey, San Diego, CA (US); Doron Greenberg, San Diego, CA (US); Steven S. Kaye, San Diego, CA (US)

(72) Inventors: Mark S. Bailey, San Diego, CA (US); Doron Greenberg, San Diego, CA (US); Steven S. Kaye, San Diego, CA (US)

(73) Assignee: WILDCAT DISCOVERY TECHNOLOGIES, INC., San Diego, CA (US)

(21) Appl. No.: 13/365,438

(22) Filed: Feb. 3, 2012

(51) Int. Cl. B05D 3/00; C09D 123/06; C09D 127/18; B02C 23/18

(52) U.S. Cl. 427/385.5; 241/21; 524/587; 524/546; 524/585

(57) ABSTRACT

A method for preparing stable dispersions of high strength polymers where the polymer particles are micron-sized or submicron-sized and dispersions and dry powders prepared from this method. The method includes swelling the high strength polymer particles and mechanically milling them to reduce particle size. Films, coatings, and other useful articles can be prepared from such dispersions and powders.

### BACKGROUND OF THE INVENTION

The present invention is in the field of processing high strength polymers into preparations, such as dispersions, that are industrially useful.

High strength polymers (or high strength plastics as they are often called) have many applications. In particular, high strength polymers are often used in applications where their structural stability is beneficial.

Ultrahigh molecular weight polyethylene (UHMWPE) is one example of a high strength polymer. UHMWPE has high abrasion resistance, a low coefficient of friction, a non-adherent surface, and chemical fatigue resistance. It performs well at extremely low temperatures.

UHMWPE is a high strength thermoplastic known to have on the order of 15 times the abrasion resistance of conventional carbon steel. In addition, the coefficient of friction for UHMWPE is comparable that of polytetrafluoroethylene (PTFE), another commercially-relevant high strength polymer. However, UHMWPE sells for a fraction of the cost of PTFE. UHMWPE finds application in a number of areas including body armor, joint replacements, and the automotive sector.

In these sectors and others, UHMWPE is processed into shapes and thick films by compaction or melt processes. Because the smallest mean particle size of UHMWPE that can be efficiently obtained is no less than 10 microns, there are a wealth of applications for which UHMWPE cannot be easily formulated. For example, UHMWPE and many other high strength polymers cannot be formulated into stable dispersions. Stable dispersions are useful in many liquid-based processing applications, including forming coatings.

Certain embodiments of the present invention address the challenges found in creating micron-sized and submicron-sized particles of high strength polymers. These and other challenges can be addressed by embodiments of the present invention described below.

### BRIEF SUMMARY OF THE INVENTION

Certain embodiments of the invention include processes for preparing a dispersion of a high strength polymer. In certain embodiments, particles of the high strength polymer are combined with a solvent capable of swelling the particles of the high strength polymer. In certain embodiments, these particles have a mean particle size greater than about 10 microns. In certain embodiments, the swelled particle and solvent combination is further combined with a processing agent. In certain embodiments, the combination of particles, solvent, and optional processing agent is introduced into a milling apparatus and the combination is mechanically milled at least until the particles have a reduced mean particle size.

Certain embodiments of the invention relate to a stable dispersion of high strength polymer particles in a liquid phase prepared by the above processes and certain embodiments relate to a substantially dry powder of high strength polymer particles further prepared from such stable dispersions.

Certain embodiments of the invention relate to methods for preparing coatings by applying a dispersion of particles of a high strength polymer to a surface and drying the applied dispersion to allow the particles of fuse, thereby forming the coating.

### BRIEF DESCRIPTION OF THE SEVERAL VIEWS OF THE DRAWING

FIG. 1 is an image taken by a scanning electron microscope of commercially-available UHMWPE particles of the prior art. The image illustrates that many of these particles have a particle size on the order of about 10 microns or larger and few particles are smaller than about 5 microns.

FIG. 2 is an image taken by a scanning electron microscope of commercially-available UHMWPE particles of the prior art that have been milled using a prior art method. The image illustrates that the particles are typically deformed rather than being reduced in size when this prior art method is used.

FIG. 3 is an image taken by a scanning electron microscope of commercially-available UHMWPE particles of the prior art that have been milled using another prior art method. The image illustrates that the particles are typically deformed rather than being reduced in size when this other prior art method is used.

FIG. 4 is an image taken by a scanning electron microscope of a dispersion of UHMWPE particles prepared from commercially-available UHMWPE particles of the prior art according to an embodiment of the present invention.

### DETAILED DESCRIPTION OF THE INVENTION

The description, figures, and examples herein relate to processes for preparing dispersions of high strength polymers, the dispersions made by these processes, and useful articles prepared from these dispersions.

Short summaries of certain terms are presented in the description of the invention. Each term is further explained and exemplified throughout the description, figures, and examples. Any interpretation of the terms in this description should take into account the full description, figures, and examples presented herein.

High strength polymers, and more specifically high strength thermoplastics, have multiple uses in products in which durability and wear-resistance are important. However, the mechanical and chemical properties that provide high strength polymers with desirable properties also make these high strength polymers difficult to process. Embodiments of the present invention are useful for improving the processability of high strength polymers. Specifically, certain embodiments of the present invention can be used to prepare dispersions of high strength polymers.

High strength polymers that can be used according to certain embodiments of the invention include wear resistant polymers with relatively high molecular weights, including but not limited to high density polyethylene (HDPE), ultrahigh molecular weight polyethylene (UHMWPE), and polytetrafluoroethylene (PTFE). In general, any polymer that would deform rather than be reduced in size under prior art milling conditions can be used with certain embodiments of the method to form dispersions and coatings therefrom.

According to certain embodiments of the present invention, high strength polymers can be processed into dispersions. A dispersion is a system of at least two materials in which one material is present in discrete phases and another material is present in a continuous phase. For example, according to some embodiments of the present invention a high strength polymeric material can be present as discrete particles dispersed throughout a liquid phase. The ratio of one material to the other will depend on the characteristics and properties of the materials and the application in which the dispersion is to be used. According to certain embodiments of the present invention, the high strength polymer maybe be present in the dispersion in an amount that ranges from about 1 weight percent to about 90 weight percent and the liquid phase may be present in the dispersion in an amount that ranges from about 10 weight percent to about 99 weight percent. Preferably, the high strength polymer is present in the dispersion at an amount less than about 80 weight percent. More preferably, the high strength polymer is present in the dispersion at an amount less than about 70 weight percent. More preferably still, the high strength polymer is present in the dispersion at an amount less than about 60 weight percent. Still more preferably, the high strength polymer is present in the dispersion at an amount ranging from more than about 40 weight percent to less than about 60 weight percent.

In a dispersion, the liquid phase can be one or more liquids. Further, the liquid phase can contain one or more processing aids such as surfactants, emulsifiers, stabilizers, UV sensitizers, polymerization catalysts or other materials known in the art to enhance the utility of dispersions. The liquid phase of the dispersion can contain one or more solvents. The choice of solvent for the dispersion depends upon the characteristics and properties of the materials and the application in which the dispersion is to be used. As described in further detail below, dispersions can be used in variety of applications, such as coating applications. For coating applications, solvents can be chosen based on properties such as viscosity, volatility, surface tension, toxicity, cost, and contact angle on the target substrate. Examples of solvents that are suitable for use in dispersions of high strength polymers include, but are not limited to, water, glycol, ether, acetone, and combinations thereof.

According to certain embodiments of the invention, the liquid phase of the dispersion can also include one or more surfactants. Surfactants facilitate the separation of particles in a dispersion. Maintaining separation of particles in a dispersion can prevent clumping and enhance the uniformity of the distribution of such particles. Surfactants can also help to prevent particles from settling out of the dispersion. Examples of surfactants that are suitable for use in dispersions of high strength polymers include: sodium alkyl sulfates, alkyl ethoxylates, acrylic acids, ammonium salts.

Dispersions are useful in a variety of applications, such as the formation of coatings. Coatings can be formed using a variety of methods, including liquid-based methods, plasma-based methods, and powder-based methods. Among these methods, liquid-based coating is often preferred because of its relatively lower cost and relatively higher efficiency than other methods. Liquid-based coating methods include a variety of methods based on brushing, dipping, spraying, or otherwise applying the liquid to the surface of the part to be coated. These different methods have different requirements for the physical and chemical properties of the dispersion and therefore can include solvents, surfactants, and other agents tailored to the application method. Many agents useful for tailoring a dispersion to a particular application can be found in the literature, such as Polymer Dispersions and Their Applications, edited by Dieter Urban and Koichi Takamura (Wiley-VCH, Verlag GmbH, Weinheim, 2002).

Dispersions formulated according to certain embodiments of the invention contain high strength polymer particles of a size that facilitates the formation of coatings. Particles size plays a role in the processability of dispersions. At a basic level, it may be difficult or impossible to form a dispersion with large particles. The limiting size for particles in a dispersion depends upon the physical and chemical characteristics of the constituents of the dispersion, such as the particles, the solvent or solvents, the surfactants or emulsifiers, and any other processing agents.

Further, the size of the particles in a dispersion can affect the applications for which a dispersion is suited. In the case of forming coatings, the specific range of particle sizes that is most suited to forming coatings depends on the physical and chemical characteristic of the constituents of the dispersion. A stable dispersion of particles of polymer coating or film material (or a film or coating precursor material) is used to create a film or coating via the liquid-based processing methods described above. Dispersions are made stable by combining appropriately-sized particles with selected solvents and any additional surfactants or other processing agents. Dispersions formulated according to certain embodiments of the present invention can be used to make coatings and films, each of which can be continuous, discontinuous, conformal, self-supporting or combinations thereof. Suitable film forming additives may also be found in the literature, such as in the above-referenced Polymer Dispersions and Their Applications.

Certain embodiments of the present invention are suitable for preparing dispersions of UHMWPE. Certain embodiments of the present invention are used to create a dispersions of micron-sized or submicron-sized particles of UHMWPE. According to certain embodiments of the present invention, such dispersions of micron-sized or submicron-sized particles of UHMWPE can fuse into coatings and films upon removal of the liquid phase, such as by drying. Further, according to certain embodiments of the present invention, stable dispersions of other commercially-available high-strength plastics can be prepared and processed into films and coatings.

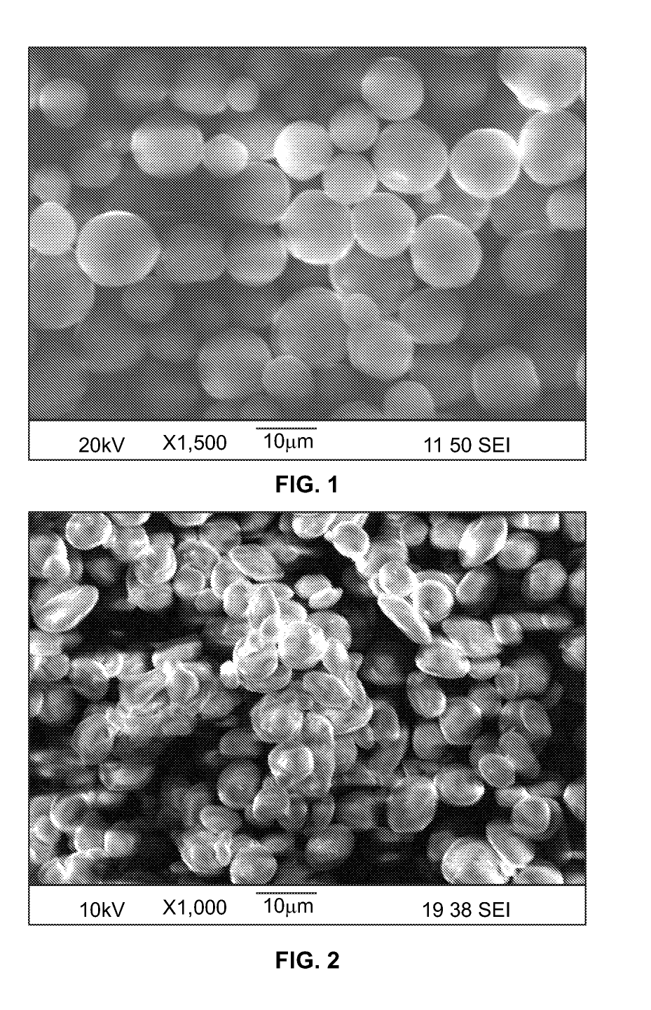

FIG. 1 is an image taken by a scanning electron microscope of commercially-available UHMWPE particles of the prior art. The image illustrates that these many of these commercially-available UHMWPE particles have a particle size on the order of about 10 microns or larger and few particles are smaller than about 5 microns. These commercially-available UHMWPE particles are generally spherical. If these large particles were able to be formulated into a stable dispersion (and it is not given that a suitable liquid phase could be formulated to place such large UHMWPE particles into a stable dispersion) such a dispersion would not easily fuse into a coating or film, if it could fuse at all into any type of coating or film.

According to the prior art, large particles are often mechanically milled to reduce their size. Mechanical milling is a low-cost industrial method to reduce particle size for various applications, including creating particles of sufficiently small size such that the particles can be formulated into stable dispersions. However, the prior art method of mechanical milling of high strength polymers such as UHMWPE does not yield particles suitable for creating stable dispersions that can be useful in coating or other applications. FIG. 2 is an image taken by a scanning electron microscope of commercially-available UHMWPE particles that have been milled using a prior art mechanical milling method. The image illustrates that the particles are typically deformed rather than being reduced in size when this prior art method is used.

Using this prior art mechanical milling method, the particles are generally not broken up into smaller particles. Instead, the particles are deformed. This type of deformation during mechanical milling is common for polymer materials with glass transition temperatures close to room temperature. Polymer materials with glass transition temperatures sufficiently higher than room temperature will be in a glassy state when mechanically milled at room temperature. In a glassy state, such polymer materials will be more likely to break into smaller particles than to deform when exposed to mechanical milling forces. In contrast, polymer materials with glass transition temperature at or below room temperature will be in a rubbery state and are generally not amenable to a mechanical milling process to reduce particle size.

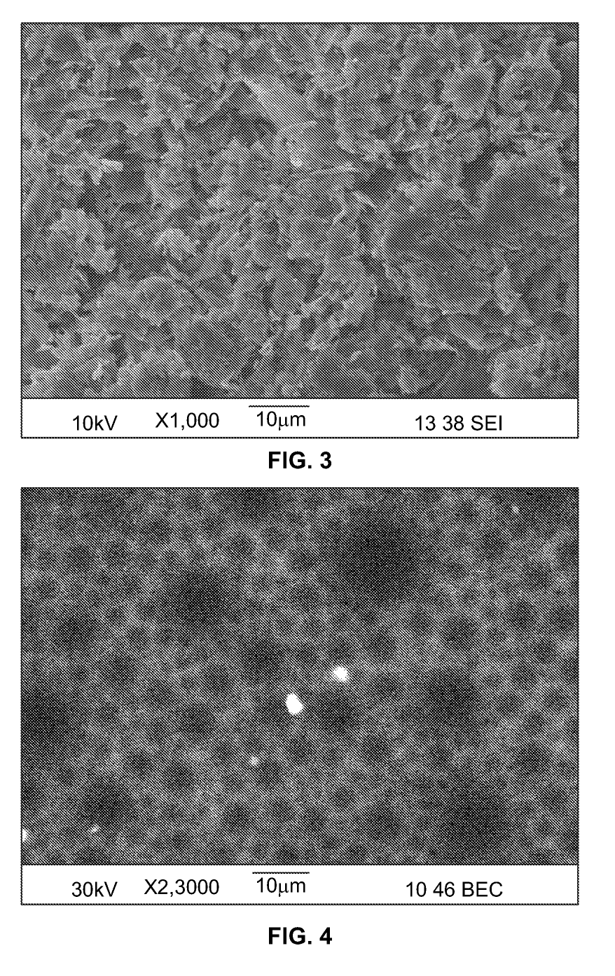

According to the prior art, a typical method to reduce the particle size of polymer materials with glass transition temperatures close to room temperature is to mechanically mill such polymeric materials at low temperatures. Using low temperatures will place the polymeric material in its glassy state such that the particles will break into smaller particles rather than deforming. FIG. 3 is an image taken by a scanning electron microscope of commercially-available UHMWPE particles that have been milled using a low temperature prior art method. The image illustrates that the particles are typically deformed rather than being reduced in size even when the particles were milled in an environment held at about the temperature of liquid nitrogen. Although the UHMWPE particles were well below their glass transition temperature, these particles were not broken up into smaller particles.

Like certain other high strength polymers, UHMWPE has excellent abrasion resistance which makes it difficult to break up UHMWPE particles even when they are mechanically milled at temperatures well below their glass transition temperature. Without being bound by any particular theory or principle, the high abrasion resistance is due to the highly intertwined nature of, and the strong intermolecular interactions between, the very long molecules of UHMWPE. The molecular weight of UHMWPE can range from about 2 million to about 6 million Daltons. Certain embodiments of the invention are useful for creating stable dispersion of high molecular weight polymers regardless of their specific chemical composition or physical properties. That is, the fact that a polymer material is high molecular weight makes it compatible with certain embodiments of the method.

One benefit of the very high molecular weight of UHMWPE and other high strength polymers is that such polymers can be swollen when exposed to certain solvents. Swelling such high strength polymers can make them easier to process and formulate. Solvents suitable for swelling UHMWPE include, but are not limited to, parafin oil, dodecane, other high-boiling hydrocarbons, and combinations thereof.

According to embodiments of the present invention, particles of high strength polymer materials are combined with solvents capable of swelling the polymer materials. In general, solvents swell a polymer material when the solvent can infiltrate the polymeric material by at least partially dissolving some of the material. For lower molecular weight polymers, certain solvents may completely dissolve a particular polymer. However, as the molecular weight of the material increases, that same solvent may be capable of swelling the polymeric material but not substantially dissolving it.

For certain combinations of high strength polymers and solvents, swelling the polymer particles may require more than simply combining the particles with the solvent. The combination of particles and solvent may be agitated through any means including stirring or sonication. The combination of particles and solvent may be heated, additionally or independently from the agitation, to facilitate swelling.

According to certain embodiments of the invention, the particles of high strength polymer can be sufficiently swelled in preparation for mechanical milling by combining them with a solvent, with or without additional means such as agitation or heating. The swelled particles may appear as a viscous fluid or jelly-like material, they may still retain the appearance of particles, or some combination of these appearances. The appropriate level of swelling will depend upon the physical and chemical characteristics of the high strength polymer. Generally, more swelling is preferable according to embodiments of the present invention.

According to certain embodiments of the invention, the combination of solvent and swelled particles can be further combined with other agents. Suitable agents include those that facilitate the formulation of a stable dispersion and those that facilitate the further processing of the dispersion into films or coatings or other useful articles. Examples of such agents can be found in the above description and include surfactants. According to certain embodiments of the invention, the combination of swelled particles and solvent is further combined with at least one surfactant. As with the initial combination of high strength polymer particles and solvent, the further combination of swelled particles, solvent, and surfactant (or other agents) may be mixed in combination with heating or agitation or both.

According to certain embodiments of the invention, the further combination of swelled particles, solvent, and any optional surfactant (or other agents) can be mechanically milled. The combination is placed into a mechanical milling apparatus, such as an attritor. The swelled particles are milled until they are reduced in size. The solution in the attritor will generally reduce in viscosity as the particle size decreases. The final dispersion may have a more fluid (or less viscous) consistency than the combination that is initially introduced into the mechanical mill.

According to certain embodiments of the present invention, the resulting dispersion contains micron-sized or submicron-sized particles of high strength polymer. This dispersion can be further formulated to be suitable for a particular application. The concentration of particles in the dispersion can be altered by increasing or decreasing the amount of liquid phase in the dispersion. Processing agents, including those described above, can be added to the dispersion to facilitate application of the coating into films or coatings or other useful articles. Further, substantially all of the liquid phase of the dispersion can be removed to yield a composition of substantially dry particles that can be useful in powder-based processing methods.

According to embodiments of the inventions, the micron-sized and submicron-sized particles of high strength polymers are substantially spherical after being processed into a dispersion. The spherical shape of the particles can reduce the viscosity of the dispersion as compared to a dispersion formed from irregularly-shaped particles. Reduced viscosity allows for a wider variety of coating application and can lead to thinner films and coatings as compared to higher viscosity dispersions. In general, the particle shape and the particle size in a dispersion will influence the flow behavior and stability of the dispersion.

The mean particle size of the micron-sized and submicron-sized particles in dispersions prepared according to certain embodiments of the invention can be determined using conventional techniques. For example, the size of the particles can be inspected using microscopic techniques, such as scanning electron microscopy. Other techniques, such as size-exclusion filtration techniques driven by gravity or centrifugation, may also be used. Still other techniques based on light scattering may be used. As used herein, the phrase “mean particle size” includes the various well-known methods and measures of the average size of particles, including median size, geometric mean size, volume-based particle size, weight-based particle size, area-based particle size, and hydrodynamic or aerodynamic particle size.

According to certain embodiments of the invention, the particles of high strength polymer in the dispersion range in size from about 0.01 microns to about 1.50 microns. In certain embodiments, the particles of high strength polymer in the dispersion range in size from about 0.05 microns to about 0.50 microns. Although the suitable particle size depends strongly on the high strength polymer and the application for which the dispersion will be used, in general a particle size less than or equal to about one micron will be suitable for forming a stable dispersion.

According to certain embodiments of the invention, the particles of high strength polymer in the dispersion are characterized as being below a maximum particle size regardless of their mean particle size. For example, according to certain embodiments of the invention, the particles of high strength polymer are substantially all less than about 1.50 microns. In certain embodiments, the particles of high strength polymer in the dispersion all substantially less than about 0.50 microns.

Among the advantages of certain embodiments of the invention is the novel development of a scalable, efficient, and relatively low-cost industrial technique for processing high strength polymer materials into stable dispersions. Such stable dispersions provide for new application of high strength polymeric materials.

The following Examples are for illustration purposes and are not to be construed as limiting the invention.

### EXAMPLE 1

### Preparation of a Stable Dispersion of Micron-Sized UHMWPE

Particles of commercially-available UHMWPE particles (Mitsui Chemical) are evaluated to determine a mean particle size of approximately 10 microns. The UHMWPE particles are then combined with paraffin oil (Sigma-Aldrich) to swell the particles. In the present example, 50 grams of UHMWPE particles are combined with 2 liters of paraffin oil and heated at about 135 degrees C. for about 10 hours. The swelling step produces a white, highly viscous jelly.

The viscous combination of swelled UHMWPE particles is placed into a solution of sodium dodecylsulfate (SDS, Sigma Aldrich) in water. In this example, 40 grams of SDS is mixed with 2 liters of water. Then, about 175 grams of swelled UHMWPE particles is combined with the SDS/water combination and the resulting combination is milled in a metal-free attritor at 350 rpm for about 6 hours. Suitable attritors include, but are not limited to a laboratory scale wet grinding attritor such as the Model 01-HDDM (Union Process).

FIG. 4 is an image taken by a scanning electron microscope of a dispersion UHMWPE particles prepared from commercially-available UHMWPE particles of the prior art according to this example.

1. A process for preparing a dispersion of a high strength polymer comprising:
combining particles of the high strength polymer with a solvent capable of swelling the particles of the high strength polymer, wherein prior to the combining step the particles have a first mean particle size;
further combining the particles and solvent with a processing agent;
introducing the combination of particles, solvent, and processing agent into a milling apparatus; and
milling the combination at least until the particles have a second mean particle size.

2. The process of claim 1 wherein the first mean particle size is greater than about 10 microns.

3. The process of claim 1 wherein the second mean particle size is less than about 3 microns.

4. The process of claim 1 wherein the second mean particle size is less than about 1 micron.

5. The process of claim 1 wherein the high strength polymer is selected from the group consisting of UHMWPE, HDPE, and PTFE.

6. The process of claim 1 wherein the high strength polymer comprises UHMWPE.

7. The process of claim 1 wherein the processing agent comprises a surfactant.

8. The process of claim 1 wherein the swelled particles form a viscous material.

9. The process of claim 1 further comprising combining a film-forming agent with the stable dispersion.

10. The process of claim 1 wherein the dispersion comprises a liquid phase and the process further comprises removing the liquid phase from the dispersion to form a substantially dry powder of high strength polymer particles.

11. A dispersion prepared by the process of claim 1.

12. The dispersion of claim 11 wherein the high strength polymer is selected from the group consisting of UHMWPE, HDPE, and PTFE.

13. The dispersion of claim 11 wherein the high strength polymer is UHMWPE.

14. The dispersion of claim 11 wherein the second mean particle size is less than about 3 microns.

15. The dispersion of claim 11 wherein the second mean particle size is less than about 1 micron.

16. The dispersion of claim 11 wherein the particles of high strength polymers in the dispersion are substantially spherical.

17. A method for preparing a coating comprising:
applying a dispersion of particles of a high strength polymer; and
drying the applied dispersion to allow the particles of fuse, thereby forming the coating.

18. The method of claim 17 wherein the high strength polymer is selected from the group consisting of UHMWPE, HDPE, and PTFE.

19. The method of claim 17 wherein the high strength polymer is UHMWPE.

20. The method of claim 17 wherein the coating is substantially conformal.
